(19) United States
(12) Patent Application Publication
(10) Pub. No.: US 2009/0193577 A1
(43) Pub. Date: Aug. 6, 2009

(54) Universal face wash and care station

(76) Inventors: Nikolai Eiteneer, Citrus Heights, CA (US); Boris Eiteneer, Irvine, CA (US)

Correspondence Address: MATHEW J. TEMMERMAN, 423 E STREET, DAVIS, CA, 95616, US

(21) Appl. No.: 12/012,732

(22) Filed: Feb. 5, 2008

(51) Int. Cl. A47K 1/04; A61H 33/00

(52) U.S. Cl. 4/650; 4/619; 607/82

(57) ABSTRACT

A universal face wash and care station for an easy and effective washing of user's face and/or scalp without need for special accommodations and preparation. One of the key features of the invention is providing a comfortable and/or ergonomically neutral user posture, such as standing upright or sitting when using the device. Another key feature is providing a hand-free face and/or scalp washing and care without preliminary preparation, such as undressing and preliminary washing of hands. In one preferred embodiment, the device comprises an interface accommodating user's head and/or neck; a distribution means for supplying, directing, and regulating working fluid flow; a delivery means for supplying working fluid to said distribution head; a receptacle for collecting spent working fluid after it had been used and for protecting the rest of user's body, user's clothes, and surroundings from getting wet; a drain for directing spent working fluid to the collection device; and a means for supporting the weight of the said device, said working fluid, and said spent working fluid. In another embodiment, the invention comfortably accommodates users of different heights and builds by changing the position of the washing device and/or receptacle with respect to their mounting points. In yet another embodiment, the invention allows the user to perform washing process without using his/her hands.

### FIELD OF THE INVENTION

The present invention relates to hygienic devices, and more specifically to face wash and care devices.

### GENERAL BACKGROUND AND SUMMARY OF THE INVENTION

For thousands of years, people had been using various devices and equipment for washing and hygienic purposes. During this time, the washing appliances have been developing along the lines of specialization and diversification, achieving high levels of sophistication. Only the procedure and equipment for face washing remain pretty much the same as they were centuries ago. The process still involves a person leaning over some sort of receptacle (sink), gathering a handful of water from water dispenser (faucet), and splashing the water over the face. Some of the drawbacks of conventional face washing process over a sink are alleviated if a person uses the shower to wash the face and/or scalp. A more comfortable posture can be adopted, and redispersion of dirt and chance of contamination from switches are reduced. However, shower usage generally implies undressing, and therefore requires more time, special provisions to ensure privacy such as showercabins, and a place to store discarded clothes and footwear. These requirements generally make installation of convenient face washing stations impractical in public places such as schools, workplaces, sport facilities, and recreational areas, other than in specifically designed restrooms, usually combined with toilets. Many users might find it less than desirable to go to the public toilet that might not be very clean to simply wash or freshen their faces or heads. Oftentimes, especially during hot weather, people are seen rinsing their faces using bottled water, drinking fountains, water hoses, and other means not particularly well adapted for face washing. While simple and habitual, the common face washing process comprises several parts that can be altered to provide a quicker, simpler, more effective, and more enjoyable face washing experience. For example, the present invention allows the user to wash his or her face and/or scalp while employing the following advantageous features:

1) readiness to use, not requiring a specific training or instructions for use;

2) installation flexibility, allowing the user to mount and use the device at any convenient location, such as in the bathroom, or on the outside house wall in the backyard, or on the pool deck, while also allowing installation and use in public places such as public bathrooms, hospitals, sport facilities, schools, showers, swimming pools, waiting rooms, transportation hubs, recreation areas, etc.;

3) independent installation in a self-contained configuration, without connection to water supply and/or drain lines;

4) allowing user to maintain a comfortable and relaxed position, such as standing upright or sitting, without the need to lean over the sink, avoiding the strain to neck and/or shoulders and lower back;

5) washing face or scalp without using hands, therefore improving hygiene, decreasing the chance of facial skin irritation due to rubbing, and without re-dispersing the dirt and sweat by hand motion;

6) washing without the risk to dampen one's sleeves, collar, and other clothes;

7) ability to wash one's face and scalp without preliminary preparation, such as undressing and preliminary washing of hands, allowing the user to maintain hygiene on the go, even in public places such as airports, bus and railway stations, etc, while saving time;

8) localized soaking of only face and scalp, eliminating the need to soak the whole person's body, as when using the shower, thereby saving time and resources such as additional water, towels, etc;

9) reduced water usage due to high utilization of running water;

10) ability to provide skin and scalp care simultaneously or sequentially with face and/or scalp washing; and

11) manufacturing simplicity;

The primary goal of the present invention is to provide means for an easy and effective washing of user's face and/or scalp without need for special accommodations and preparation. The process of washing using the present invention is extremely simple and natural and does not require any specific training. This feature is especially advantageous for small children, as well as persons with learning disabilities, and will make the process of washing much more enjoyable for them. The advantages of the present invention make it especially valuable for elderly and persons with permanent or temporary disabilities such as persons in wheelchairs or casts, people experiencing back or neck pains and aches, or with otherwise limited mobility.

Another explicit purpose of the present invention is to provide comfortable accommodation of users of different heights and builds by changing the position of the washing device and/or receptacle with respect to their mounting points. This feature is particularly advantageous for the installation of the washing device at residential homes, child care centers, hospitals, public establishments, and elderly care facilities, when each person, especially children, elderly, and disabled, will be able to easily move the washing device in the most comfortable position for washing. The user will be able to maintain a comfortable and relaxed position, such as standing upright or sitting, without the need to lean over the sink, avoiding the strain to neck and/or shoulders and lower back. A number of configuration elements can be included into the construction of the washing device to allow for translational movement of the receptacle up and down and/or left and right, as well as pivotal movement around the mounting point.

Yet another purpose of the present invention is to provide a hand-free face and/or scalp washing and care without preliminary preparation, such as undressing and preliminary washing of hands, and allows the user to maintain hygiene on the go, even in public places such as airports, bus and railway stations, etc, while saving time. Moreover, washing face or scalp without using hands could improve hygiene, decrease the chance of facial skin irritation due to rubbing, and eliminating re-dispersion of the dirt and sweat by hand motion, while simultaneously reducing the possibility of dampening one's sleeves, collar, and other clothes. Hands-free operation of the,washing device allows localized soaking of only face and/or scalp, eliminating the need to soak the whole person's body, as when using the shower, thereby saving time and resources such as additional water, towels, etc. The washing device of the present invention can be equipped with the hands-free controls such as sensors, pedals and/or levers to turn the working fluid flow on and off, as well as to alter the temperature and other characteristics of working fluid flow.

The present invention also has substantial environmental advantages such as reduced water usage due to high utilization of running water specifically for face/scalp wash, as opposed to intermittent filling of hands with water. When a person uses his/her hands to collect running water to splash on the face, only the collected part of water flow is used, while a large portion of running water is discarded when it is not collected in hands. If a conventional “water-ondemand” switch is used to provide water in short bursts, the washing process becomes very cumbersome, and the chance of hand re-contamination when pressing the switch increases dramatically, especially in public washing facilities.

The present invention can also be combined with existing sinks, faucets, showerheads, etc. offering ease and flexibility of installation and minimizing manufacturing costs. These and other advantages of the present invention will become clear from the descriptions of the preferred embodiments thereof. While the invention has been described in connection with what is presently considered to be the most practical and preferred embodiments, it is to be understood that the present invention is not to be limited to the disclosed embodiments, but on the contrary, is intended to cover various modifications and equivalent arrangements included within the spirit and scope of the appended claims.

### DESCRIPTION OF THE PRIOR ART

The U.S. Pat. No. 3,768,483 to Kusunoki describes a facial sauna for face treatment with hot steam and skin care agents. Kusunoki's invention provides for a hands-free face cleansing and care and offers a tilt-adjustable hood specifically shaped to comfortably accommodate user's face. However, the U.S. Pat. No. 3,768,483 teaches only use of steam as face cleaning agent, and does not allow use of hot or cold water, which might be preferred by users depending on a number of conditions (ambient temperature, for example). Moreover, Kusunoki's apparatus is limited to the batch use of cleansing agents and does not have a continuous operation mode. No provisions are made for easy replacement or cleaning of the device's parts that come into contact with user's face, nose, or mouth; therefore, the device is not readily adaptable for using in public facilities. Further, the U.S. Pat. No. 3,768,483 does not address position adjustment of the hood or application of the invention for scalp or hair treatment.

The U.S. Pat. No. 4,223,668 to Lamy and Forget describes a face massager that is essentially a conical flexible mask fitting over user's face. Their invention provides for face cleaning and massaging by pressurized water action and can be used anyplace where pressurized water is available, for example, connected to an existing faucet. However, the invention described in U.S. Pat. No. 4,223,668 does not provide for scalp or hair treatment, nor does it address using of cleansing or skin care agents. Since the apparatus described is essentially a full-face mask, it does not allow the user to use his or her hands to aid face washing. The invention as described is not hands-free. The described water dispensing means do not allow regulation of water pressure or massaging intensity. Furthermore, no provisions are made for easy replacement or cleaning of the device's parts that come into contact with user's face or nose; therefore, the device is not readily adaptable for using in public facilities.

The U.S. Pat. No. 4,281,423 to Fukunaga et al. describes a foam bathing apparatus that allows cleansing and massaging of user's face or other parts of human body, such as the hand, elbow, or foot. The device comprises a means of adjusting the air pressure such that a gentler or more vigorous massaging action is achieved. However, Fukunaga et al. do not teach position adjustment of the bathing apparatus or any other means that would allow users to change their posture and/or position relative to the device. Furthermore, the described invention operates in the batch mode only and lacks provisions such as disposable or easily cleaned elements that would make it suitable for use in public places.

The U.S. Pat. No. 5,181,510 to Peters teaches a portable facial vaporizing device that allows the user's face to be exposed to warm water vapors with or without face care agents such as essential oils. While the facial vaporizing device is intended to be used with existing faucets and can be made disposable, that invention does not teach a hands-free operation of the device. The U.S. Pat. No. 5,181,510 does not teach height adjustment of the facial vaporizing device to provide a more comfortable user position. Moreover, Peters does not teach any face or scalp massaging action in conjunction with her invention, nor does she mention using hands for additional face care or other hygienic purposes.

The U.S. Pat. No. 6,712,290 to Chien describes a skin cleaner that uses a first liquid that is squirted from the nozzle over the user's face received in the bowl, while a second liquid is converted into vapor and then discharged into the opening of the bowl. This skin cleaner provides cleansing and massaging action to user's face. This invention does not teach adjustment of the skin cleaner to provide a more comfortable user position or use of hands to enhance the cleansing action. Furthermore, the described invention operates in the batch mode and lacks provisions such as disposable or easily cleaned elements that would make it suitable for use in public places.

The U.S. Pat. No. 4,587,680 to Brugger describes a hair washing basin for hairdressers. The basin has a recess for the nape of the users neck and certain shape imparting circular motion on the water that flows towards evacuation opening to improve washing of long hair. Brugger's invention is explicitly intended to be used by hairdressers and does not teach hands-free operation or face washing and care. Furthermore, Brugger does not describe adjustment of the basin position to allow more comfortable user's position than a conventional leaning backwards towards the basin.

The U.S. Pat. No. 4,933,998 to Arnet teaches a drip tray for a solution applied to the head of the user. The described tray has a neck opening and is made of flexible material to provide a resilient fit around user's neck. Further, the tray has a trough shape for collection of spent liquid. Arnet's tray is intended for collecting only a small amount of fluid and does not include any provisions for continuous drainage. The U.S. Pat. No. 4,933,998 teaches only treatment of hair wherein the tray is located mostly behind user's neck and does not teach face washing or care.

The U.S. Pat. No. 5,023,963 to Vogel describes a self-adjusting and self-securing shampoo tray accommodating users of various heights sitting in upright position. This tray contains an arcuate neck receiving opening and directs the runoff flow into a receiving basin. The explicit purpose of Vogel's invention is to protect the user's body and clothes from the fluid spill-off during hair treatment and to direct spent fluid to drainage. Vogel's invention does not teach face washing or care and needs to be worn by the recipient during use.

The U.S. Pat. No. 4,233,693 to Stocklow teaches an easy-to-use height-adjustable washbasin. While providing the adjustable sink suitable for example for children, adults, and people confined to wheelchairs, U.S. Pat. No. 4,233,693 does not teach sinks specifically aimed at face,washing. The U.S. Pat. No. 4,233,693 does not discuss modified sink configurations, hands-free face washing, or special faucets specifically intended for face and/or scalp washing and care.

The U.S. Pat. No. 4,821,347 to Nash teaches an extensible shampoo bowl designed for individual confined to a wheel chair. It describes a height-adjustable shampoo bowl that might include a neck scoop with a rubber or resilient strip for accommodating a person's neck. The adjustment means described in that patent link the upward and outward motion of the shampoo bowl and do not provide for independent vertical and horizontal adjustments thereof. Nash's invention describes an apparatus specifically aimed at washing the hair of a person confined to a wheelchair or bed and does not describe washing of person's face apart from washing his or her hair. The shampoo bowl as described in U.S. Pat. No. 4,821,347 requires a second person to wash the client's hair and does not address hands-free washing process.

The U.S. Pat. No. 6,076,202 to Lockwood teaches a shampoo sink system, comprising adjustable telescoping support assembly lockable in a number of fixed positions and specifically intended to shampoo hair of people with disabilities and the like. Lockwood's invention can be adapted to a number of heights and includes provisions to position user's neck in the neck receiving depression and to prevent dripping of wash water on user's body and clothes. As described, Lockwood's invention requires user to lean into the shampooing sink. The U.S. Pat. No. 6,076,202 does not teach hands-free face washing or special faucets specifically intended for face washing and care.

The U.S. Pat. No. 6,665,892 to Crocilla describes an apparatus for washing person's hair, comprising a movable washbasin with a forward pointing lip to receive a person's head or neck. One of the stated goals of Crocilla's invention is to minimize entry of water, shampoo, and treatment agents onto the face of client. The U.S. Pat. No. 6,665,892 teaches the arcuate motion of the washbasin that inherently links upward and downward motion to the translational motion closer to or away from the client and does not provide for independent vertical and horizontal adjustments of the washbasin. Moreover, the U.S. Pat. No. 6,665,892 specifically describes a washing apparatus designed to be used in conjunction with a barber's chair by a person (hairdresser) other than the client.

The U.S. Design Pat. No. 412,741 to Pepin teaches an adjustable height sink module. From the drawings it can be seen that while providing for the vertical adjustment of the sink that patent does not address a washing apparatus specifically aimed at washing person's hair or scalp, nor does it provide for a comfortable accommodation of person's head or neck. Furthermore, the design U.S. Pat. No. 412,741 does not refer to using any skin or hair treatment agents.

The U.S. Pat. No. 3,731,325 to Garassi describes a portable hair wash sink attachment. Guarassi teaches an attachment that fits a front wall of a common sink and serves to direct the spent water used for hair washing away from the user and into the sink drainage, protecting the user from water spill during hair wash. Guarassi's invention also includes an adjustable neck yoke that can fit necks of various sizes, as well as a curved dish for placement under user's chin to collect spent water and protect user from spills. The U.S. Pat. No. 3,731,325 describes a device aimed specifically at washing hair and does not teach face washing or treatment. The U.S. Pat. No. 3,731,325 to Guarassi does not teach height adjustment of the described sink attachment to maintain a comfortable posture, nor does it teach a hands-free operation.

The U.S. Pat. No. 3,934,596 to Suntheimer et al. describes a shampooing apparatus that can be operated manually or in a pre-programmed manner. The shampooing apparatus of Suntheimer et al. is constructed with a sink in front of which the person preferably sits with face directed substantially downwardly. The apparatus also has a nozzle array for dispensing a shampoo, crème rinse, or rinse water, and a mixing chamber for mixing hot and cold water prior to dispensing through the nozzle array. Suntheimer et al.'s invention guards user's face, body and clothes, as well as surroundings, during hair washing from getting wet. Sealing means for user's face include a preferably rubber face rest. The apparatus also provides means for controlling working fluid characteristics (temperature) and cycle features (rinse, crème, shampoo, etc.) and can be used in a stand-alone configuration. Suntheimer et al.'s invention is intended for hair wash and treatment only, and does not teach face washing or care. Moreover, this invention does not provide for utilization of user's hands to enhance cleansing and/or massaging when desired. Also, the U.S. Pat. No. 3,934,596 does not teach a height adjustment to accommodate users of different heights, nor does it allow the user to comfortably stand or sit upright while using the shampooing apparatus. Suntheimer et al.'s invention does not discuss changeable or adjustable sealing means to provide accommodation of users of different builds and head sizes, nor does it provide for easy cleaning and/or disposable sealing elements.

The U.S. Pat. No. 4,385,408 to Rhodes describes a sanitary cushioning device for sink bowl edges. Rhodes' invention teaches a flexible and resilient means to support user's neck while washing hair over a sink. Rhodes does not teach face washing or treatment, does not describe height adjustment of the sanitary cushioning device to maintain a comfortable posture, nor describes a hands-free operation for washing or treating face or scalp. Moreover, Rhodes' invention must be used in conjunction with an existing sink.

The U.S. Pat. No. 5,239,711 to Tafur teaches a headrest for shampoo bowls and sinks that is removable and adjustable to different neck lengths and head sizes. Tafur's invention must be used in conjunction with an existing sink and external water supply. The U.S. Pat. No. 5,239,711 does not teach height adjustment of the described headrest to maintain a comfortable posture, nor does it teach a hands-free operation.

The U.S. Pat. No. 5,946,745 to Magee describes a shampooing device that includes a pair of interlocking bowls and a drainage tank that eliminate the need for a conventional sink and further eliminate the need for client to bend his or her neck during a hair cleaning process. The bowls are supported in part by client's shoulders and further in part by a pair of arms that form a part of a height-adjustable stand that at least partially supports the weight of the bowls. Magee's invention further includes a cape that guards the client from splashing water. The cape is secured in place by a belt member and can be further tightened around client's neck if needed. Still further, Magee's invention includes a liquid-delivery hose with a liquid-dispensing nozzle equipped with a trigger. While Magee's shampooing device has a number of advantages discussed in the patent application, there are a number of drawbacks. First, Magee's invention is specifically designed for hair washing, and does not provide for a convenient face wash and care. Secondly, Magee's invention requires a second person, or service provider, to set up the interlocking bowls of the shampooing device and perform the actual hair washing of the client. Due to its rather complex design with two bowls, guard cape, and other features, Magee's device requires a substantial time to set up and cannot be used unassisted. Moreover, since a part of the device's weight is supported on client's shoulders, its use can be uncomfortable, especially for people with disabilities, elderly, and small children. Further, Magee's device does not provide for a hands-free operation, and requires at least one hand of the service provider to operate the flexible liquid-delivery hose with a nozzle to aim the water flow to the area to be washed, making the hair washing process quite cumbersome and complicated. The client needs to be seated in order for the service provider to be able to comfortably reach client's hair. Magee's invention does not describe any splashguard elements, and does not prevent the service provider from getting wet from splashing water.

The U.S. Pat. No. 6,415,458 to McFadden describes a portable shampooing device that has basin having central opening, non liquid permeable sleeve secured around opening, and elastic collar strap integrated to sleeve. McFadden's invention allows the user to maintain a comfortable posture, protects user from spills and directs spent fluid to the drainage opening, and is specifically aimed at accommodating user necks of different sizes. The U.S. Pat. No. 6,415,458 does not teach the hands-free operation and requires an external source of working fluid.

The U.S. Pat. No. 6,694,540 to Mazzulla et al. describes a hair washing apparatus that includes a basin supported by a support structure and a flexible tube providing a sealing means to guard person's head and face from getting wet during hair washing. The support structure is height adjustable to allow for a comfortable user posture. Further, the support structure has a set of wheels providing for an easy setup and removal of the hair washing apparatus. Spent liquid is directed to the lower end of the basin and further to the drain by an attached connection tube.

While functional for its intended purpose, the invention of Mazzulla et al. is specifically designed for hair washing, and does not provide for a convenient face wash and care. Also, Mazzulla et al.'s invention requires a second person (hair dresser) to set up the hair washing apparatus and perform the actual hair washing of the client. The device described by the U.S. Pat. No. 6,694,540 does not provide for a hands-free operation and cannot be used unassisted. Further, Mazzulla et al.'s invention does not describe any splashguard elements to prevent the service provider from getting wet from splashing water and does not address means of supplying the working fluid to client's hair and therefore depends on conventional means such as water faucets and hoses.

The U.S. Pat. No. 5,940,885 to Matthews describes a head washing cap made mostly of elastic material. Matthews' invention directs spent water via a water channel to a drain (not described). While the head washing cap of U.S. Pat. No. 5,940,885 is applicable to users of different head sizes, it is expressly designed to prevent water from coming in contact with a face of a user and does not discuss hands-free operation or position adjustment to allow for a more comfortable user posture.

The U.S. Pat. No. 6,291,051 to Shimizu describes a waterproof sheet for hair washing. Shimizu's invention is designed to prevent water leaks during the hair washing process and is specifically applicable to persons of different sizes, including children. However, Shimizu teaches about application of the waterproof sheet only to hair washing, and does not discuss face wash or care. Moreover, Shimizu's invention is specifically designed to be used with a conventional automatic hair washing apparatus and does not address adjustment of the position of the hair washer to allow for a more comfortable user posture.

The U.S. Pat. No. 6,519,777 to Speelman describes a hair washing body shield that prevents user's face, clothing, and body from becoming wet while the user's hair is washed or otherwise treated with substantial volume of liquid. Speelman's invention describes a sheet member that includes a sealing means forming a water proof seal around the user's head and can be adjusted for different user head sizes, said sheet member directing spent fluid to a collection hose or tank. Speelman's invention is designed to allow for a comfortable user's posture (sitting upright as opposed to tilting back over a shampoosink). However, Speelman's invention does not teach face treatment or care, nor does it provide for a hands-free operation. As described, Speelman's invention impiles a second person (hair dresser) to set up the hair washing body shield and perform the hair washing. Moreover, U.S. Pat. No. 6,519,777 does not address means of supplying the working fluid to user's hair and therefore depends on conventional means such as water faucets and hoses.

### BRIEF DESCRIPTION OF THE FIGURES

The foregoing aspects and many of the attendant advantages of the invention will become more readily appreciated as the same becomes better understood by reference to the following detailed description, when taken in conjunction with the accompanying drawings, wherein:

FIG. 1 is a schematic diagram of the first preferred embodiment of the universal face wash and care station of the present invention;

FIG. 2 is an illustration of the first preferred embodiment of the universal face wash and care station in three views;

FIG. 3 is a detail of the user interface of the first preferred embodiment that can further include removable collars of various shapes and forms;

FIG. 4 is the preferred embodiment of the height-adjustment mechanism of the universal face wash and care station of the present invention;

FIG. 5 is a schematic diagram of another preferred embodiment of the universal face wash and care station incorporating a blender which meters a prescribed concentration of an additive to the working fluid;

FIG. 6 is a further detail of the preferred embodiment of the height-adjustment mechanism of the universal face wash and care station;

FIG. 7 is a schematic diagram of yet another preferred embodiment of the pedestalmounted universal face wash and care station of the present invention; and

FIG. 8 is a schematic diagram of still another preferred embodiment of the mobile universal face wash and care station of the present invention.

### DETAILED DESCRIPTION OF THE INVENTION

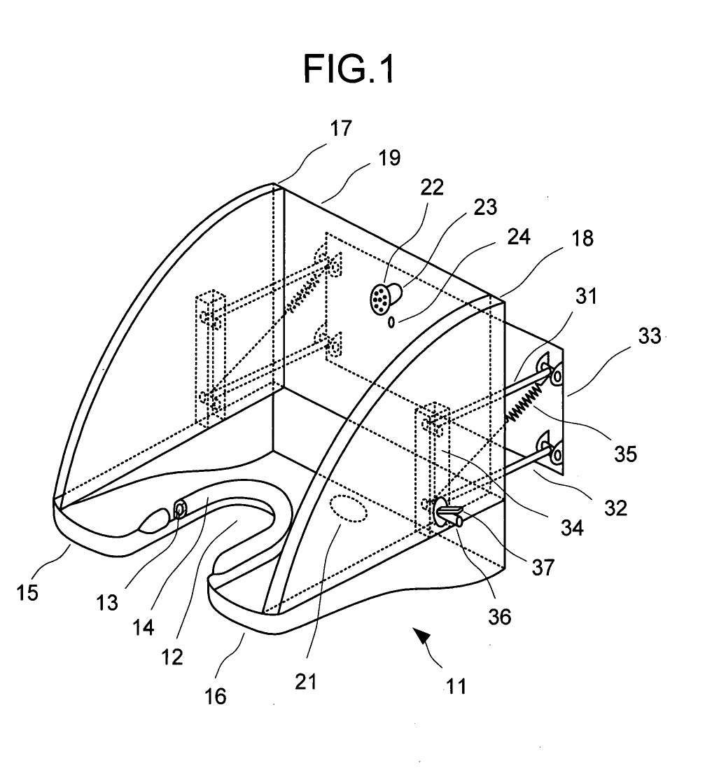

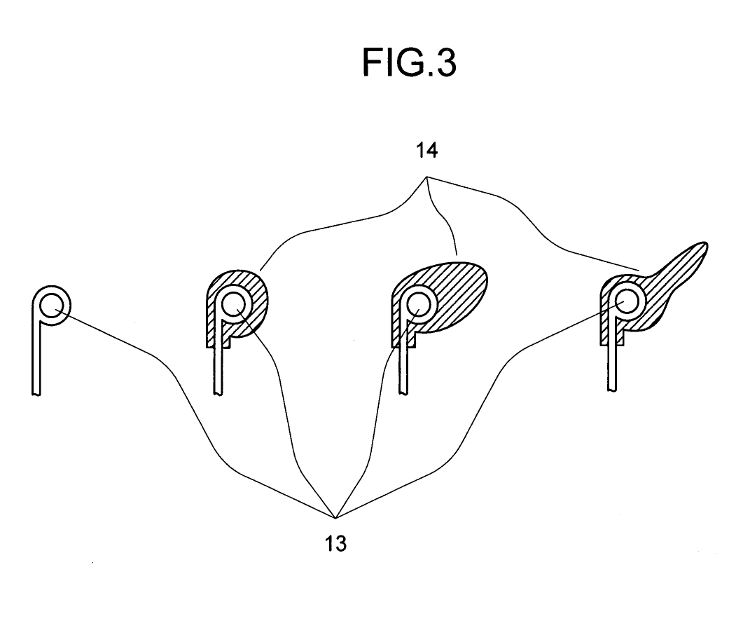

Referring to FIG. 1, the first embodiment of the present invention includes a receptacle 11, which serves as an integrating structure for the other components of the washing device and provides a general work area for the user to wash his/her face and/or scalp. The receptacle 11 also collects spent working fluid (most commonly, water) after it had been used for washing and protects the rest of user's body and/or clothes, except the area to be cleaned, from getting wet. The most common working fluid used for washing in the present invention is pure water. To provide enhanced washing experience, other types of working fluids can also be used, for example, water containing additives such as cleansing agents, skin care agents, etc. The receptacle 11 offers a user interface via a cutout 12 for accommodation of user's neck. Cutout 12 is dimensioned such as to provide a comfortable fit for a range of neck sizes commonly encountered in persons of average build and height. Alternatively, cutout 12 can be sized to fit less common individual neck size(s). Cutout 12 further incorporates a rounded lip 13 fitting at least a part of the user's neck and/or head. To ensure protection of user's body and/or clothes from getting wet, the preferred embodiment of the present invention provides for a watertight fit between user's neck and the receptacle 11. For this purpose, cutout 12 is fitted with a collar 14, manufactured from a soft, flexible, resilient, and non-allergenic material (for example, plastic) for comfortable, relaxed, and watertight fit. The flexibility of collar 14 allows it to be snap-fitted over a rounded lip 13. In FIG. 1, a portion of the collar 14 and rounded lip 13 is removed to show how the collar 14 fits over the rounded lip 13. The collar 14 can be made removable to replace with different shape and size and to facilitate the cleaning of the washing device. To provide a comfortable fit for users of different builds, a number of interchangeable collars 14 of slightly different shapes and dimensions as shown in FIG. 3 can be provided. To further improve sanitary condition of the washing device, the removable collars 14 can be made disposable.

Returning to FIG. 1, the receptacle 11 provides means for attachment of wing portions 15 and 16. Wing portions 15 and 16 protect the rest of user's body and/or clothes and surroundings from possible splashing of the working fluid. Wing portions 15 and 16 can be and integral part of the sink, or be either fixed or detachable. Alternatively, the wing portions 15 and 16 can be an integral part of the receptacle 11, as shown in preferred embodiment of FIG. 1.

Wing portions 15 and 16 direct the flow of the spent working fluid towards the drain opening 21, located at the lower rear portion of receptacle 11. In a preferred embodiment, the wings 15 and 16 as well as receptacle 11 have inclined bottoms for directing spent working fluid to the said drain opening 21 by force of gravity. The drain opening 21 directs spent working fluid through the drain line further to a fluid collector or existing drain line (not shown). In a fixed installation of the washing device, the collector can simply be a pre-existing drain line. In a self-contained or mobile cart installation of the washing device, the collector can be a tank that needs to be periodically emptied after it has been filled with the spent working fluid. The preferred embodiment of FIG. 1 further comprises removable splashguards 17 and 18, preventing water from splashing outside of receptacle 11 during washing. Rear panel 19 bounds the washing space on the side opposite to the user. A mirror can be mounted on the rear panel 19 to allow the user to view his/her face and/or scalp before or-after washing.

A distribution head 22 supplies the working fluid to the area to be washed. To improve efficiency of the washing process and reduce working fluid usage, an aerator (not shown) can be included as a part of the distribution head 22. To further enhance the efficiency of the washing process, the distribution head optionally allows alteration of the working fluid flow. The flow can be altered, for example, between a gentle smooth flow and a more vigorous and/or pulsating flow by using distribution heads known in the art. It is also possible to arrange the flow of the working fluid in such a manner as to provide a massaging action simultaneously with washing.

To further enrich user's experience and better adapt to a wider variety of washing scenarios, the washing station of the present invention might allow switching the flow between two or more working fluids. For example, the first working fluid might be a hot water containing a small amount of liquid soap to thoroughly wash user's face, while a second working fluid might be a lukewarm clear water to rinse off the user's face after it has been washed. Alternatively, different users might want to use different working fluids for various purposes. For example, the first user might want to use a vigorous flow of hot water with soap to thoroughly wash the sweat and dirt from his face, while the second user might want to use a gentle flow of cool water to simply cool off her face on a hot day. A single-lever valve known in the field for controlling working fluid temperature and opening/shutting off the flow of working fluid can be included as a user operated means for controlling flow characteristics of working fluid.

In the embodiment illustrated by FIG. 1, the distribution head 22 is shown mounted on arm 23. The arm 23 can be either fixed or movable. The mounting of distribution head 22 can be either fixed on the arm 23 or have a pivot joint allowing the distribution head 22 to be aimed at a desired spot on the users' face or scalp. Arm 23 connects distribution head 22 with a working fluid supply line (not shown). Arm 23 and supply line are mounted on the different sides of the rear panel 19, for example, using a bulkhead fitting. To simplify operation of the washing device, a sensor switch 24 can be incorporated into invention. When user places his/her head or face in the work area, the sensor switch will turn the working fluid flow on. After user removes his/her head from the work area, the sensor switch 24 will turn the working fluid flow off.

The washing device of the present invention as illustrated by the preferred embodiment of FIG. 1 can be lowered or raised to a position most comfortable for the user utilizing a pair of parallelogram lever gears located at the opposite sides of receptacle 11. Considering the lever gear closest to the viewer in FIG. 1, supporting arms 31 and 32, mounting base 33, and extension arm 34 construct a parallelogram. Supporting arms 31 and 32 provide means of attaching the washing device to the support structure via a mounting plate 33 and serve for raising and lowering the washing device to a required height. To counteract the weight of receptacle 11, a spring 35 is employed as shown in FIG. 1. The counter-balance action of spring 35 allows easy height adjustment of the receptacle 11, reducing the force that the user needs to apply to vertically move the receptacle 11. User can raise and lower the receptacle 11 to a desired height by operating the handle 36. A latch lever 37 attached to the handle 36 allows user to lock the receptacle 11 at a desired height. The splashguards 17 and 18 can simultaneously serve as covers for the configuration elements. For example, the splashguard 17 as shown in FIG. 1 serves as cover for the supporting arms 31 and 32.

The mounting plate 33 of the embodiment shown in FIG. 1 can be permanently fixed to the bathroom wall. Also, the mounting plate 33 can be attached to the bathroom wall in a manner allowing for the horizontal adjustment of the washing device of the present invention by the means known in the art. Such means can incorporate sliding horizontal rails providing a translational adjustment in horizontal direction. Alternatively, the mounting plate 33 can be hinged to the bathroom wall such that to allow a pivoting movement of the washing device of the present invention in horizontal direction. Other means of providing a horizontal adjustment of the washing device can also be used within the scope of the present invention.

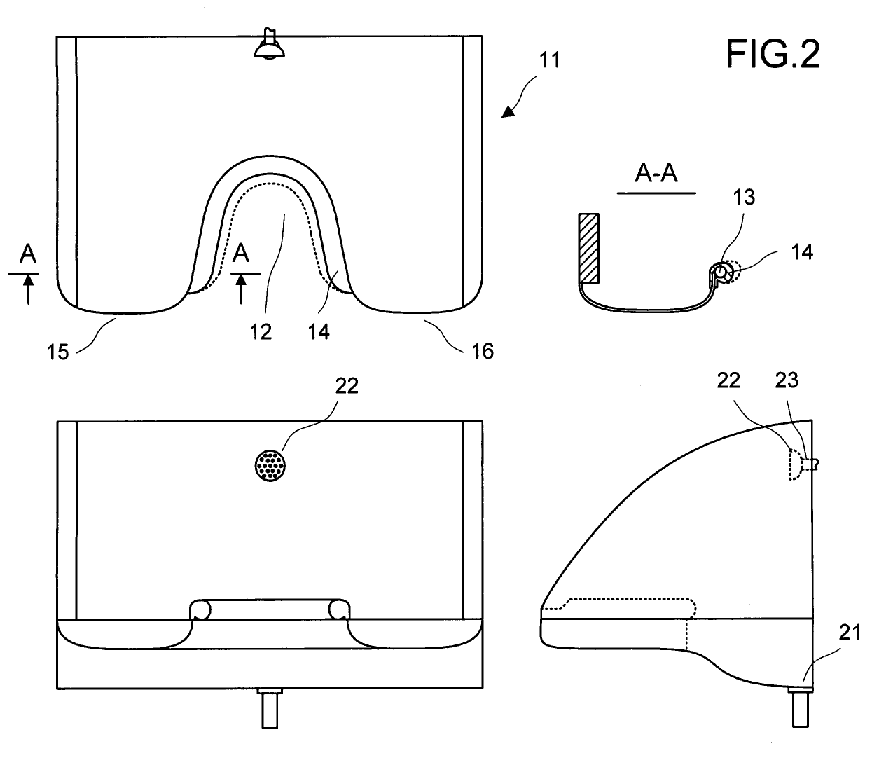

FIG. 2 further illustrates receptacle 11, attached wing portions 15 and 16, cutout 12 with rounded lip 13 and attached collar 14, distribution head 22, mounting arm 23, and drain opening 21 in three views of the preferred embodiment.

FIG. 3 shows the detail of the rounded lip 13 of the cutout 12. Specifically, FIG. 3 illustrates in detail how the collar 14 fits over the rounded lip 13 in the preferred embodiment of the present invention. As shown in FIG. 3, different shapes and sizes of collar 14 can be used to provide comfortable neck accommodation for users of different builds and neck sizes. Various types of collars 14 shown in FIG. 3 are removable and interchangeable with each other.

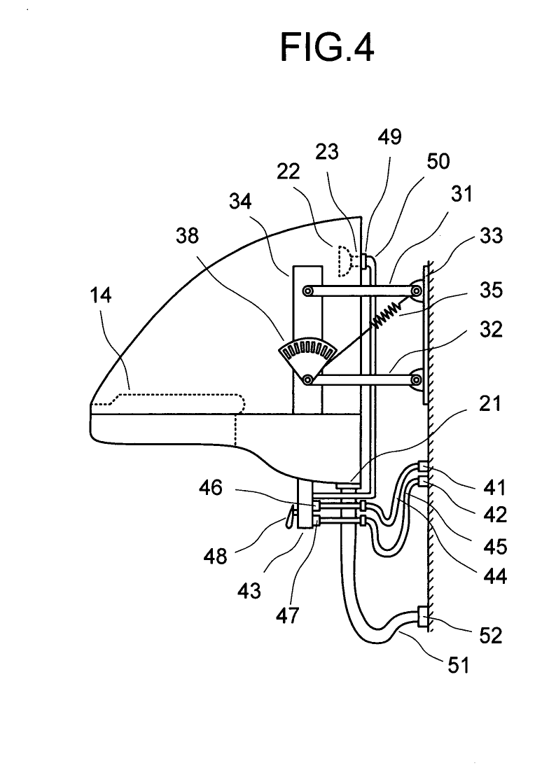

FIG. 4 further illustrates the preferred embodiment of the height-adjustment mechanism in accordance with the present invention. The washing device employs two lever gears mounted symmetrically on the side surfaces of the receptacle 11. A pair of upper and lower supporting arms 31 and 32 are pivotally mounted at one end to the stationary mounting base 33 that is fixed to an external wall or stand. The other ends of supporting arms 31 and 32 are connected to the extension arm 34. The arm 34 is in turn affixed to the receptacle 11. As shown in FIG. 4, the supporting arms 31 and 32 are of equal length and parallel to each other. Therefore, supporting arms 31 and 32, extension arm 34 and mounting base 33 form a parallelogram. In the preferred embodiment supporting arms 31 and 32 are arranged in the vertical plane. At the end of the lower supporting arm 32 there is a latch wheel segment 38. The latch wheel segment 38 is a part of a latch mechanism that allows user to lock the receptacle 11 at a desired height. To counteract the weight of receptacle 11, a spring 35 is employed as shown in FIG. 4. The counterbalance action of spring 35 allows easy height adjustment of the receptacle 11, reducing the force that the user needs to apply to vertically move the receptacle 11.

Also shown in FIG. 4 are main elements of the washing device of present invention that supply the working fluid to the distribution head 22. In this preferred embodiment, the working fluid is water delivered from cold-water tap 41 and hot-water tap 42 to the mixer 43 via flexible supply lines 44 and 45. It is advantageous to provide a working fluid pressure independent of the supply line pressure, to ensure that the working fluid jet is always aimed at approximately the same spot within the washing device, and is not falling short of the user's face due to low fluid pressure, or, conversely, is not supplied at very high pressure such as to cause uncomfortable sensations. For this purpose, inline working fluid pressure regulators 46 and 47 are provided in the preferred embodiment. Any fluid pressure regulators known in the art can be used, for example, regulators including a diaphragm. In-line pressure regulators 46 and 47 maintain constant water pressure at the inlets to the mixer 43. A single-lever valve 48 serves for controlling working fluid temperature and opening/shutting off the flow of working fluid and allows user to control flow characteristics of working fluid. In the simplest form, this includes only one water supply line (cold water). In the scope of the present invention, any other means of controlling and adjusting flow and temperature of the working fluid known in the art, such as pedals, pushbuttons, handles, knobs, etc. can be utilized. From the outlet of mixer 43 the water of desired temperature flows to the bulkhead fitting 49 via line 50 and subsequently to the distribution head 22 via the mounting arm 23. The spent working fluid is collected by the receptacle 11 and wing portions 15 and 16 and is directed to the drain hole 21 by the force of gravity. Drain line 51 further directs the spent working fluid to drain tap 52. The working fluid supply lines 44 and 45 and the spent fluid drain line 51 are flexible to allow vertical movement of the receptacle 11 with respect to the fixed mounting base 33 while maintaining integrity of working fluid supply to the washing device.

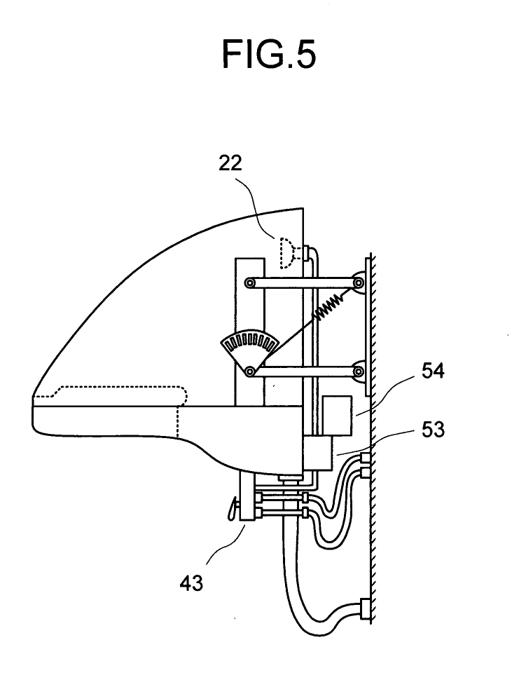

FIG. 5 illustrates another embodiment of the present invention. In this embodiment, the working fluid (water) of desired temperature is directed from the outlet of the mixer 43 to the blender 53 which meters a prescribed concentration of an additive from the additive tank 54 into the working fluid and can further include a regulator to change mixing ratio of water and additive. The additive-containing working fluid is further directed to the distribution head 22 via line 50 similar to FIG. 4. The additive can be water softener, liquid soap or other detergent, moisturizer, shampoo, aromatizing agent, essential oil, or other skin or hair care substance or a mixture of these.

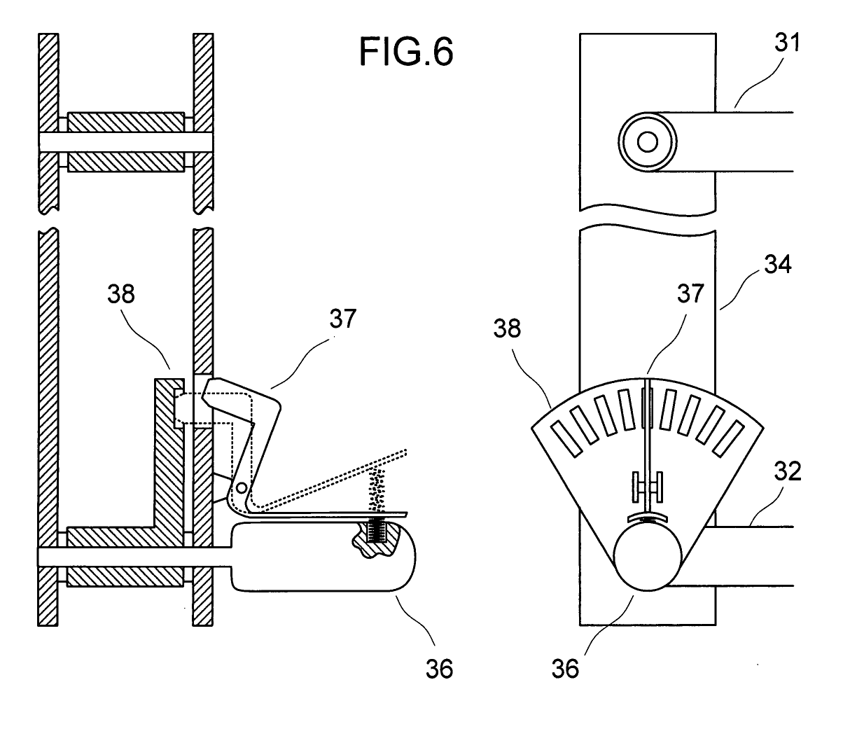

Details of the latch mechanism of the preferred embodiment of the present invention are further illustrated in FIG. 6. The latch mechanism includes a spring-loaded latch lever 37 attached to the handle 36. The latch lever 37 can engage or disengage the latch wheel segment 38 at the end of the lower supporting arm 32. The handle 36 is mounted on the extension arm 34. The base of the handle 36 serves as a rotation axis for the lower supporting arm 32. When the latch lever 37 engages the latch wheel segment 38, vertical movement of the receptacle 11 is arrested, fixing receptacle 11 at a certain height. When the latch lever 37 is disengaged from the latch wheel segment 38, the lower supporting arm 32 can be pivoted about the mounting base 33, and the vertical position of receptacle 11 can be changed. Handle 36 can be attached to the receptacle 11 from right and/or left sides, respectively, allowing both right- and left-handed users to comfortably adjust height of the receptacle 11.

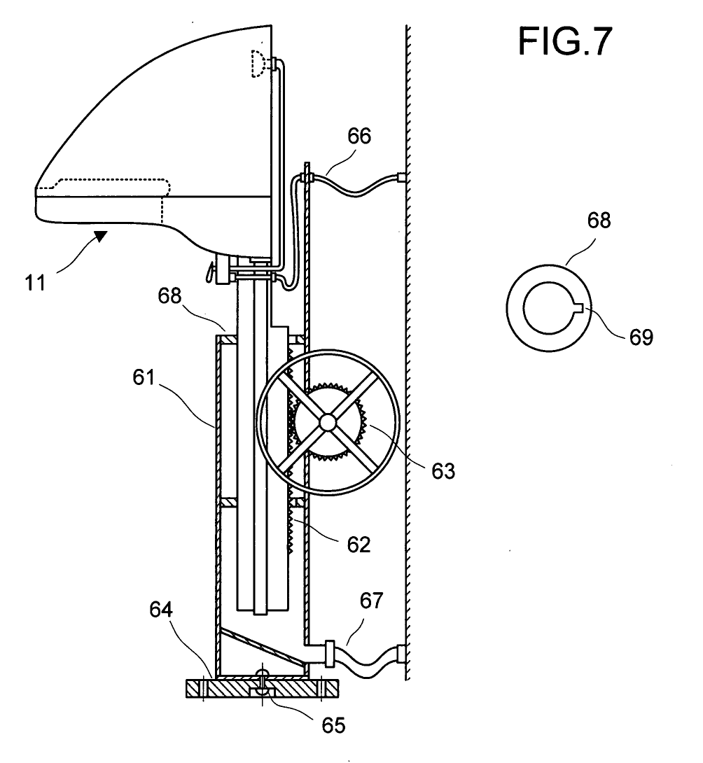

FIG. 7 shows a pedestal-mounted embodiment of the present invention. This embodiment does not require an external wall for supporting the receptacle 11; instead, an integral support stand, or pedestal 61 is provided as a part of the washing device. A rack-and pinion gear 62 and 63 incorporated in the support stand 61 is used to raise and lower the washing device with respect to its mounting point. The pedestal-mounted embodiment of FIG. 7 can be fixed to the floor using a mounting plate 64. To allow a better positioning of the washing device, the integral support stand 61 can be made to pivot about the mounting plate 64 via a pin 65 or any other means known in the art. A working fluid supply line 66 and a spent working fluid drain line 67 can be made flexible to facilitate desired positioning of the integral support stand 61. Also shown in FIG. 7 is a top cover 68 of the integral support stand 61 that allows accommodation of the rack 62 via a cutout 69.

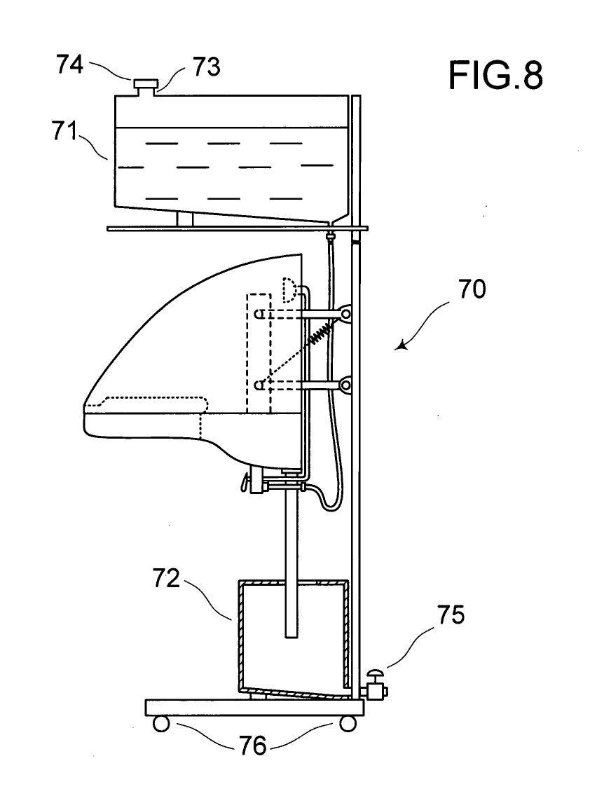

In the preferred embodiments of the present invention, the working fluid can be supplied either from an external source such as standard faucet connection as shown in FIGS. 4 and 5, or from a dedicated tank. FIG. 8 illustrates as yet another embodiment of the present invention a self-contained and mobile washing station 70 that incorporates the washing device with the dedicated working fluid supply tank 71 and the spent fluid collector 72 into the single unit. The working fluid supply tank 71 can be filled with working fluid via the opening 73 that can be capped with a cap 74. The spent fluid from collector 72 can be drained using a drain valve 75. The washing station shown in FIG. 8 further incorporates a set of wheels 76 to provide for a mobile configuration. Such a mobile configuration can be relatively easily moved from one place to another, providing a greater flexibility in operation of the present washing device. The self-contained and mobile washing station 70 will be especially advantageous at public events such as sport competitions, fairs, festivals, etc. due to simplicity of set up and removal after a public event. Benefits of the self-contained and mobile washing station 70 will also be apparent in a number of other scenarios, such as a hospital or office building installation. The washing station 70 will allow easy re-configuration of the office or workspace. For example, the washing station can be moved across the hall, or even from one floor of the building to another. A further advantage of the self-contained and mobile washing station is the ease of maintenance. Depending on the complexity of the required maintenance, the washing station unit could be replaced with another similar unit and taken to a remote maintenance facility to be serviced or recharged. In yet another embodiment, the mobile washing station can utilize the external supply of the working fluid, such as a regular water faucet, and/or an external spent fluid collector, such as drain pipe. To facilitate connection of the washing device to the external supply/collection lines, standard line connectors are preferred.

With respect to the above description then, it is to be realized that material disclosed in the applicant's drawings and description may be modified in certain ways while still producing the same result claimed by the applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

1. A device for washing face and/or scalp, said device comprising:
a. An interface providing accommodation for user's head and/or neck
b. A distribution means for supplying, directing, and regulating working fluid flow
c. A delivery means for supplying working fluid to said distribution head
d. A receptacle for collecting spent working fluid after it had been used
e. A drain for directing spent working fluid to collection device
f. A supporting means for supporting the weight of the said device, said working fluid, and said spent working fluid;
g. said device operated by user him/herself and not requiring a service provider;
h. said device is configured in such a way as to allow a comfortable and/or ergonomically neutral user posture, such as standing upright or sitting when using the device;
i. where said distribution means direct said working fluid immediately to the area to be treated;
j. said distribution means maintain set pattern and characteristics of the working fluid flow without employing user's hands during washing process;
k. said receptacle protects the rest of user's body, user's clothes, and surroundings from getting wet and directs spent working fluid to said drain;
l. said supporting means completely eliminate the need for user to support any part of the weight of the said device, said working fluid, and said spent working fluid.

2. The device according to claim 1, further comprising configuration elements allowing comfortable accommodation of users of different heights and builds by changing the position of said washing device and/or said receptacle with respect to their mounting points.

3. The device according to claim 1, allowing the user to perform washing process without using his/her hands.

4. The device according to claim 1, where said interface is a cutout in the said receptacle.

5. The device according to claim 1, where said interface includes elements providing a seal between part of user's body and said receptacle.

6. The device according to claim 5, where said sealing elements have various shapes and are removable and interchangeable.

7. The device according to claim 6, where said sealing elements are disposable.

8. The device according to claim 5, where said sealing elements include an elastic collar around at least a part of the user's neck.

9. The device according to claim 1, where said distribution means allow alteration of the pattern of working fluid flow directed to the area being cleaned.

10. The device according to claim 9, where said alteration of flow pattern provides massage action.

11. The device according to claim 1, allowing switching between two or more different working fluids.

12. The device according to claim 1, where said distribution means further comprise a user operated means for controlling flow characteristics of working fluid.

13. The device according to claim 12, where said user-operated control means further include single-lever valve for controlling working fluid temperature and opening/shutting off the flow of working fluid.

14. The device according to claim 1, further comprising a sensor switch adapted for detecting the placement of user's head or face in the treatment area, said switch turning the working fluid flow on and off.

15. The device according to claim 1, where said working fluid further contains additives.

16. The device according to claim 15, where said additives further comprise cleansing or other skin care agents.

17. The device according to claim 1, further comprising elements for performing cosmetic and/or therapeutic procedures for skin and/or scalp care.

18. The device according to claim 1, where said receptacle further includes splashguard(s) protecting the rest of user's body and/or clothes, except the area to be cleaned, from getting wet.

19. The device according to claim 2, where said configuration elements allow changing the position of said washing device and/or said receptacle with respect to their mounting points in horizontal and/or vertical direction.

20. The device according to claim 1, said device further incorporating a refillable working fluid supply tank and a spent fluid collector, said device configured to be installed in a self-contained manner, not requiring connections to external working fluid supply or drain lines.
